(19) United States
(12) Patent Application Publication
(10) Pub. No.: US 2010/0048164 A1
(43) Pub. Date: Feb. 25, 2010

(54) EMERGENCY CALL SYSTEM USING NFC TECHNOLOGY

(76) Inventor: Karim Boutihane, Le Mans (FR)

Correspondence Address: HOGAN & HARTSON LLP, ONE TABOR CENTER, SUITE 1500, 1200 SEVENTEENTH ST, DENVER, CO, 80202, US

(21) Appl. No.: 12/299,467

(22) PCT Filed: Apr. 27, 2007
(86) PCT No.: PCT/IB2007/051573

§ 371 Date: Sep. 15, 2009

(30) Foreign Application Priority Data
May 4, 2006 (EP) 06300440.2

(51) Int. Cl. H04B 7/15; H04M 11/04

(52) U.S. Cl. 455/404.2; 455/11.1

(57) ABSTRACT

An emergency call system having an emergency call sensing apparatus for transmitting an emergency radio signal upon sensing an emergency event, and at least one mobile unit, which can be located near the emergency call sensing apparatus to receive the emergency radio signal and to establish subsequently an emergency call to a predefined destination. The respective radio interface units of the emergency call sensing apparatus and the mobile unit handling emergency radio signal communications implement NFC technology, so that the emergency call sensing apparatus is able to freely access the mobile unit without using any access control command data generated by the mobile unit.

### CROSS-REFERENCE TO RELATED APPLICATIONS

The present application is a U.S. national filing of PCT/IB2007/051573 filed Apr. 27, 2007, which is incorporated by reference herein in its entirety.

### FIELD OF THE INVENTION

The present invention relates to an emergency call system and more particularly to a system that comprises an emergency call sensing apparatus operative to trigger an emergency signal and a mobile phone configured to relay the signal through a communication call to an emergency call center.

### BACKGROUND OF THE INVENTION

Emergency call systems are known for transmitting emergency call data such as location data of a fire or a vehicle accident.

U.S. Pat. No. 6,340,928 describes an apparatus comprising a vehicle crash sensing system including a first port using Bluetooth technology to transmit a crash signal indicative of a sensed vehicle crash condition and a cellular phone having a second port using Bluetooth technology to receive the crash signal. The apparatus described in U.S. Pat. No. 6,340,928 further enables wireless communications between the cellular phone and an emergency station in response to receive the crash signal.

The set up of such an apparatus to initiate an emergency call requires tedious procedures be carried out by the operator to establish connections between the port devices. This results in an increase of emergency response time.

### SUMMARY OF THE INVENTION

The object of the invention is to propose a simpler emergency call system which minimizes emergency response time.

One embodiment of the invention accordingly relates to an emergency call system that includes an emergency call sensing apparatus comprising:

an emergency event sensor adapted to sense an emergency event and to provide a command to send an emergency radio signal;

a first wireless communication device adapted to communicate with a mobile unit to send an emergency radio signal upon receipt of the command sent by the emergency event sensor; and

an emergency control unit to coordinate tasks, to handle a communication with the mobile unit through the first wireless communication device and to provide emergency call data in case of an emergency event sensed by the emergency event sensor.

Another embodiment of the present invention further includes a mobile unit which can be located near the emergency call sensing apparatus that comprises:

a second wireless communication device adapted to communicate with the first wireless communication device to receive the emergency radio signal,

a third wireless communication device adapted to establish an emergency call through a wireless public communication network to a predefined destination upon receipt of the emergency radio signal, and

a mobile control unit to coordinate tasks between the second wireless communication device and the third wireless communication device.

The emergency call system can be characterized in that the first wireless communication device implements Near Field Communication (“NFC”) technology to transmit the emergency radio signal, and the second wireless communication device implements NFC technology to receive the emergency radio signal from the emergency call sensing apparatus. Additionally, the emergency call sensing apparatus is able to freely access the mobile unit without using any access control command data generated by the mobile unit.

According to particular embodiments, the emergency call system can also have one or more of the following characteristics. These characteristics include:

an emergency call sensing apparatus comprising an emergency call storage unit containing the emergency call data related to the emergency radio signal as prerecorded voice codec data and/or emergency call sensing apparatus positioning data;

an emergency call sensing apparatus comprising a positioning signal receiver unit to provide data to be incorporated into the emergency radio signal as emergency data;

an emergency call sensing apparatus comprising a voice codec unit able to convert an analog voice message into a prerecorded voice data message to be incorporated into the emergency radio signal;

a mobile unit comprising a mobile storage data base to store the totality of the emergency data sent by the emergency call sensing apparatus;

a mobile unit comprising a positioning receiver unit to receive mobile positioning data, and means for encapsulating the mobile positioning data with the emergency call data to provide complete emergency call data to be sent to the predetermined destination through the third wireless communication device;

a mobile unit comprising an emergency call disabling device able to deactivate the second wireless communication device in response to a user command;

an emergency call system comprising:
a plurality of mobile units, able to be located near the emergency call sensing apparatus, each mobile unit including a second wireless communication device implementing NFC technology; and
the emergency call sensing apparatus is able to freely access each mobile unit of the plurality without using any access control command generated by each unit of the plurality; and

a mobile unit of the plurality comprising means for establishing an emergency call to the same predefined destination when the unit receives an emergency signal from the emergency call sensing apparatus.

According to another embodiment of the present invention, the emergency call method can utilize an emergency call sensing apparatus comprising a means for segmenting the emergency radio signal into a number of data blocks or transmission bursts using an Automatic Request protocol (“ARQ”) to transmit all the data of the emergency radio signal.

The invention also relates to a method for emergency assistance in an emergency call system, the method comprising the steps of

determining the occurrence of an emergency event;

transmitting an emergency radio signal through a wireless communication using NFC technology, when an emergency event has been sensed;

receiving the emergency signal transmitted through the wireless communication using NFC technology; and

processing the signal without using any access control command data generated by the source of the emergency signal using NFC technology.

### BRIEF DESCRIPTION OF THE DRAWINGS

A better understanding of the invention will be facilitated by reading the following description, which is given solely by way of example and with reference to the drawings, in which:

FIG. 1 is a block diagram of an emergency call system comprising an emergency call sensing apparatus and two mobile phones for one embodiment of the invention;

FIGS. 2A, 2B, 2C, and 2D are formats illustrating the data structure of four instructions used in the NFC data protocol exchange by the emergency call system according to the above embodiment;

FIG. 3 is a flow chart illustrating an end-to-end sequence of an emergency call followed by the emergency call system according to the above embodiment with one mobile phone activated only; and

FIG. 4 is a detailed flow chart illustrating a sequence of an emergency call data transfer from the emergency call sensing apparatus to the activated mobile phone unit according to the above embodiment.

### DESCRIPTION OF EMBODIMENTS

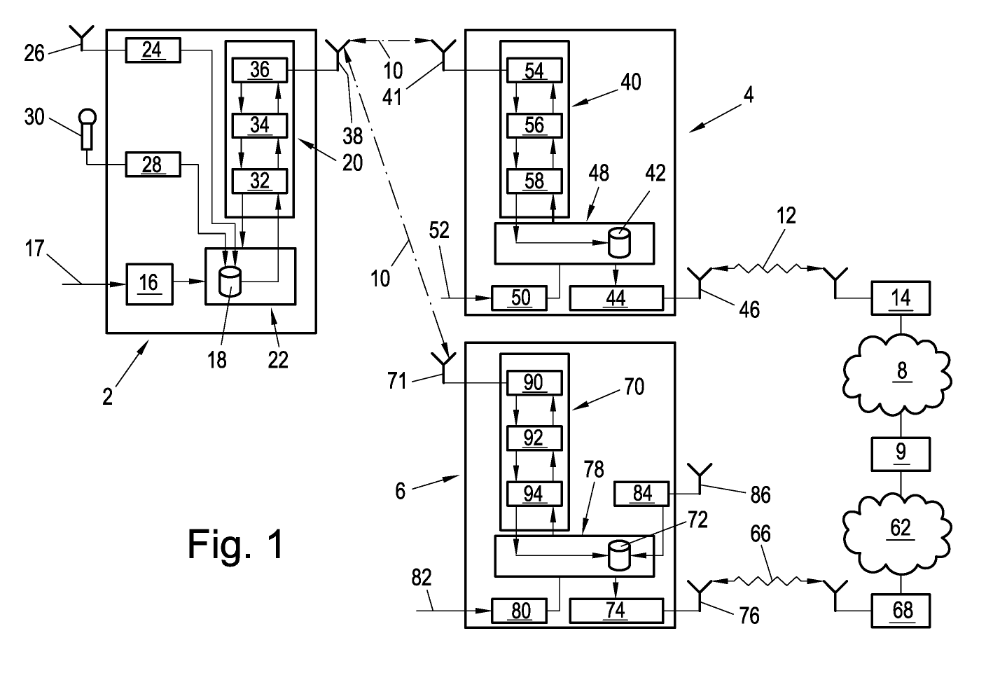

The emergency call system illustrated in FIG. 1 aimed at carrying out emergency calls comprises an emergency call sensing apparatus 2, here a vehicle crash sensing apparatus.

The emergency call system also comprises a plurality of mobile phone units 4 and 6, each unit being able to establish a usual network call with an emergency call center 7. Only two phone units 4, 6 are shown. According to the invention, all the mobile phone units are able to establish an NFC wireless link.

A first mobile phone unit 4 integrated within a first cellular network 8, herein a GSM network, is provided to relay the emergency call from the emergency call sensing apparatus 2 to the emergency call center 9. The first mobile phone unit 4, called Global System for Mobile Communication (“GSM”) mobile phone hereafter, is connected to the emergency call sensing apparatus 2 through an NFC wireless link 10 using NFC technology. The emergency call center 9 is connected to the GSM mobile phone 4 through the GSM network 8 and a GSM mobile radio link 12 handled by a GSM base station 14 belonging to the GSM network 8.

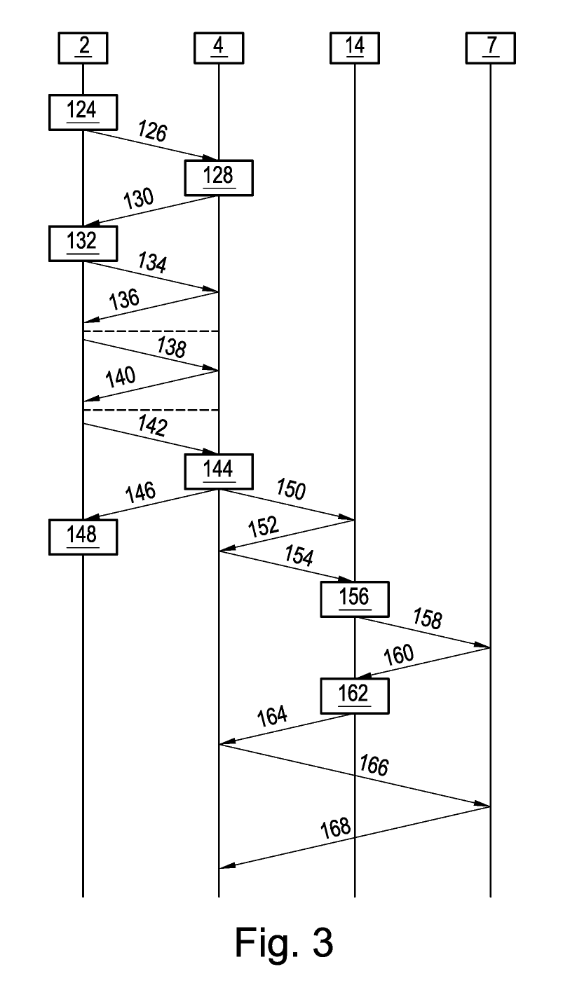

The emergency call sensing apparatus 2, the initiator, comprises an emergency event sensor 16, here a vehicle crash sensor such as an accelerometer, to trigger an emergency call upon the detection of an emergency event 17, here a sudden acceleration, and includes an emergency sensing storage database 18 to store emergency call data. It comprises also a wireless port 20 using NFC technology, an initiator NFC port to transmit the emergency call data, and a control unit 22 for the coordination of tasks as explained with reference to FIG. 3.

The Near Field Communication is a very short-range Radio Frequency Identification (“RFID”) protocol based on an inductive 13.56 MHz RF link that provides easy and secure communications between various devices without user configuration. This standardized protocol published by the ECMA-340 group as NFCIP-1 document allows users to transfer content between devices, make payment transactions, and access content from smart objects.

Additionally, the emergency call sensing apparatus 2 comprises a GPS receiver 24 to process positioning signals received from a Global Positioning System (“GPS”) antenna and to provide the sensing emergency database 18 with resulting positioning data. The emergency call sensing apparatus 2 also comprises a digital voice coder 28 to code a voice message from a microphone 30 and store the digital voice message obtained in the emergency sensing database 18.

The GPS receiver 24 and the digital voice coder 28 are both connected to the emergency sensing data base 18 and the control unit 22, so that both positioning data and recorded digital voice message are incorporated into the emergency call data. The initiator NFC port 20 comprises an initiator NFC port controller interface unit 32 to handle the emergency call data seized according to the NFC data exchange protocol, and sent by the control unit 22 and to handle messages corresponding to an NFC data exchange protocol sent by the GSM mobile phone 6. The initiator NFC port 20 also comprises an initiator NFC port frame builder/debuilder 34 to perform bit coding and decoding, frame generation and a check, CRC/parity generation and a check according to an NFC protocol, and initiator NFC port analog circuitry 36 to drive the output, modulation/demodulation and RF (Radio Frequency) level detection. The initiator NFC port analog circuitry 36 is connected to an emergency call sensing apparatus NFC antenna 38 to radiate an RF field and transmit a request NFC signal.

The GSM mobile phone 4 comprises a target NFC port 40 using NFC technology to receive through a mobile phone NFC antenna 41 the NFC signal transmitted from the initiator NFC port 20 and to transmit response NFC signals, includes a GSM mobile phone storage database 42 to store the emergency call data received from the target NFC port 40, a GSM mobile phone communication interface 44 to send the emergency call data to the base station 14 through a GSM mobile communication antenna 46, and a GSM mobile phone controller 48 for coordination of the mobile phone tasks. Additionally, the GSM mobile phone 4 comprises an NFC interface enabling/disabling device 50 to authorize/inhibit reception by the target NFC port 40 when an NFC interface enabling/disabling command 52 is received.

The target NFC port 40 comprises target NFC port analog circuitry 54, a target NFC port frame builder/debuilder 56, and a target NFC port controller interface unit 58, which have the same functionalities as the initiator NFC port analog circuitry 36, the initiator NFC port frame builder/debuilder 34, and the initiator NFC port controller interface unit 32 respectively.

A second mobile phone unit 6 integrated with a second cellular network 62, here a Universal Mobile Replacement System (“UMTS”) network, is provided as a second emergency assistance means to relay the emergency call from the emergency call sensing apparatus 2 to the emergency call center 7. The second mobile phone unit 6, called the UMTS mobile phone hereafter, is able to be connected to the emergency call sensing apparatus 2 through the same NFC wireless link 10 as used by GSM mobile phone. The emergency call center 7 can be connected to the UMTS mobile phone through the UMTS network 62 and a UMTS radio link 66 handled by a UMTS base station 68 belonging to the UMTS network 62. The UMTS mobile phone 6 has the same architecture and functionalities as the GSM mobile phone 4 regarding emergency features. In this respect, UMTS mobile phone 6 comprises a UMTS target NFC port 70 using NFC technology, a mobile phone NFC antenna 71, a UMTS mobile phone communication interface 74 to send the emergency call data to the UMTS base station 68 via a UMTS communication antenna 76, a UMTS mobile phone controller 78, and an NFC interface enabling/disabling device 80 to be actuated by an enabling/disabling command 82.

An additional mobile phone localization receiver 84 connected to a localization antenna 86 is provided in the UMTS mobile phone to enrich the emergency call data, stored in the UMTS storage data base 72, with positioning data related to the UMTS mobile phone 6. The UMTS target NFC port 70 has the same architecture and functionalities as the target NFC port 40 regarding NFC features. The UMTS target NFC port comprises UMTS target NFC port analog circuitry 90, a UMTS target NFC port frame builder/debuilder 92, and a UMTS target NFC port controller interface unit 94. These components (90, 92, 94) are respectively the same as GSM target NFC components (36, 34, 32) respectively.

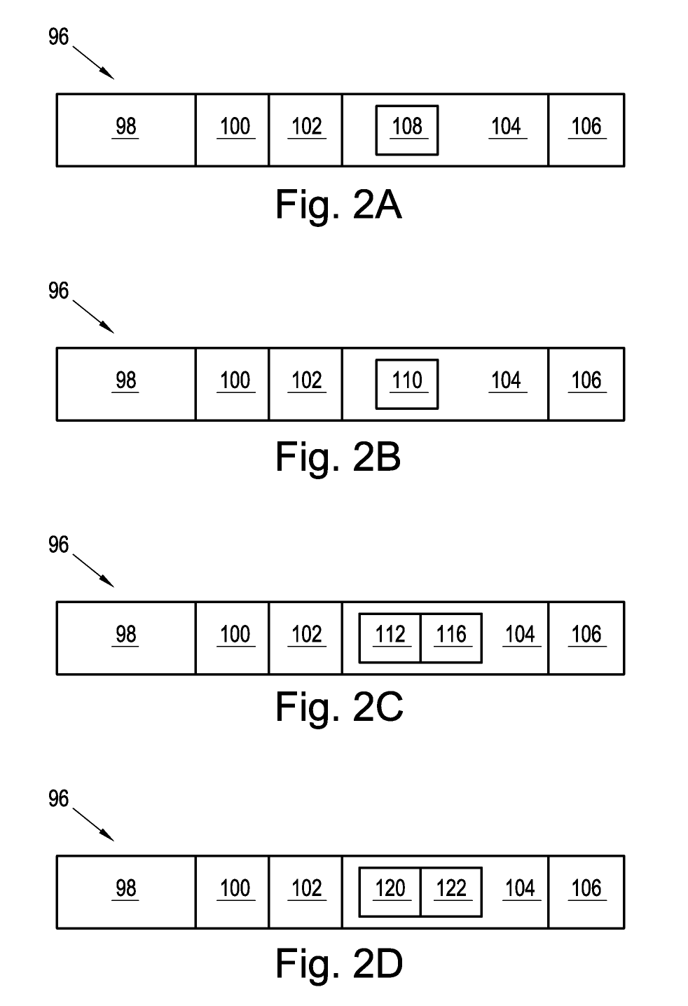

Requests are the NFC signals sent by the initiator wireless port 20. Responses are NFC signals sent by the enabled target NFC port, here NFC port 40. NFC signals, requests, and responses are formatted according to a frame structure 96 as illustrated in FIGS. 2A, 2B, 2C, and 2D. The NFC frame 96 comprises a preamble sequence 98, a synchronization field 100 of two bytes, a length field 102 set to the number of bytes to be transmitted, a transport data field containing an instruction belonging to an instruction set, a check sum 106 or CRC calculated to length field 102 and transport data field 104 according to a predetermined formula.

The instruction set used by the emergency call system according to the above embodiment to handle the NFC data exchange protocol, comprises four types of instructions: an attribute request command 108, an attribute response command 110, a data exchange protocol request command 112, 116, and a data exchange protocol response command 120, 122. The attribute request command 108 used by the initiator NFC port 20 to control the presence of a target NFC port 40 emits RF own field comprising a set of predetermined fixed bytes. The attribute response command 110 used by the target NFC port to inform it detected the RF field, radiated by initiator 2, comprises a set of predetermined fixed bytes.

Based on the NFC data exchange protocol, half-duplex protocol supporting block oriented data transmission with error handling, the emergency call data are divided into a sequence of data blocks B(i) individually containing 128 bytes. The data exchange protocol request command 112, 116 used to send the data block B(i), comprises a first request data exchange field 112 of two predetermined fixed bytes and a data exchange request variable field 116 depending on the content of B(i). An acknowledgement ACK(i) depending on the results of a Cyclic Redundancy Check (“CRC”) 106 carried out on the received data exchange protocol request command 112, 116 indicates the reception status of data block B(i). The data exchange protocol response command 120, 122 used to inform the initiator NFC port 20 about the reception status of data block B(i) comprises a first data exchange response field 120 of two predetermined fixed bytes and a data exchange response field 122 depending on the content of ACK(i).

In operation, the emergency call protocol using NFC technology as illustrated in FIG. 3 is initiated by the emergency call sensing apparatus 2, which controls the NFC data exchange protocol until the completion of the transfer of the emerging call data in the mobile phone. Before execution of the emergency call protocol, the following conditions are adhered to and steps are carried out. The emergency call sensing apparatus is set in an idle mode in which the crash sensor 16 permanently monitors the emergency conditions whereas the initiator NFC port is switched off. Upon a crash of the vehicle, a crash acceleration is detected by the crash sensor 16, which triggers the initiation of an emergency call described by step 124, as the initial step of the emergency call protocol shown in FIG. 3. In step 124, the pre-recorded voice message through microphone 30 and digital voice coder 28 stored in the emergency sensing data base 18 is assembled with actual positioning data provided by GPS receiver 24. These emergency call data are then read by the control unit 22 which also controls the data transfer to the initiator port 20. The initiator NFC port starts the formatting of data into frames that correspond to a required command. Finally, in step 124, the initiator NFC port is ready to start the communication by setting its own RF field radiating at 13.56 MHz and its NFC communication mode in an active communication mode. According to the NFC protocol, the active communication mode is the mode in which both initiator NFC port and target NFC port use their own RF field to transmit information.

The initiator NFC port 20 sends an attribute request command 108 in step 126 by modulating the RF field with the data corresponding to the initiator NFC port request. The target NFC port 40 detects the RF field generated by the initiator NFC port 20, receives and decodes the request in step 128. Upon receipt of the attribute response command sent in step 130 by the target NFC port 40, the sensing apparatus 2 determines in step 132 the sequence of emergency call data blocks B(i) and the number N of the data blocks B(i) from the emergency call data described above. Then, by implementing the same method, the target NFC port 40 responds in step 130, using its own RF field by sending an attribute response command 110.

The attribute response command 110 does not transport any access data assigned to the target NFC port 40. The attribute response command indicates only that the target NFC port 40 detected the RF field generated by the initiator NFC port 20. No access information data related to the target NFC port are transported by the target port to the initiator port. Then, the transfer of each data block B(i) following an Automatic Repeat Request (“ARQ”) method is carried out.

Firstly, the initiator NFC port starts to send in step 134 the emergency call data described above through a first data exchange NFC protocol request command that contains the data block B(1). Then, the target NFC port 40 responds to first data block B(1) in step 136 with a first data exchange NFC protocol response command containing an acknowledgement command ACK(1) to indicate the status of the reception of data block B(1) by the target NFC port 40.

The same method is used for each data block B(i) by sending an associated data exchange NFC protocol request command in step 138 and responding with a corresponding data exchange NFC protocol response command. After sending the last data block B(N) in step 142, the mobile phone unit 4 stores in step 144 in its storage data base 42 all the successful data blocks B(i) that form the emergency call data received. The mobile phone unit 4 sends a final acknowledgment information to the sensing apparatus 2 in step 146 which sensing apparatus returns to its initial state in step 148. Then, the GSM mobile phone 4 establishes an emergency call with the emergency call center 7 to transfer the emergency call data.

Firstly, the mobile phone unit sends a request to get a radio link channel to the base station 14 in step 150. The base station 14 responds by providing in step 152 a signaling message to establish the radio link. Then, the mobile phone sends a request for a usual emergency call with emergency call center 7 to the base station 14 in step 154. The base station 14 relays this request to the emergency call center 7 in steps 156 and 158, which call center responds in step 160 by sending signaling data to establish a network link. Once the network link has been established in step 162, the base station 14 sends a command to the GSM mobile phone 4 in step 164 to start the transfer of the emergency call data as defined above to the emergency call center 7 through the base station 14. The data transfer having been completed, the emergency call center 7 sends an acknowledgment command to the GSM mobile phone 4 through the base station 14 in step 168.

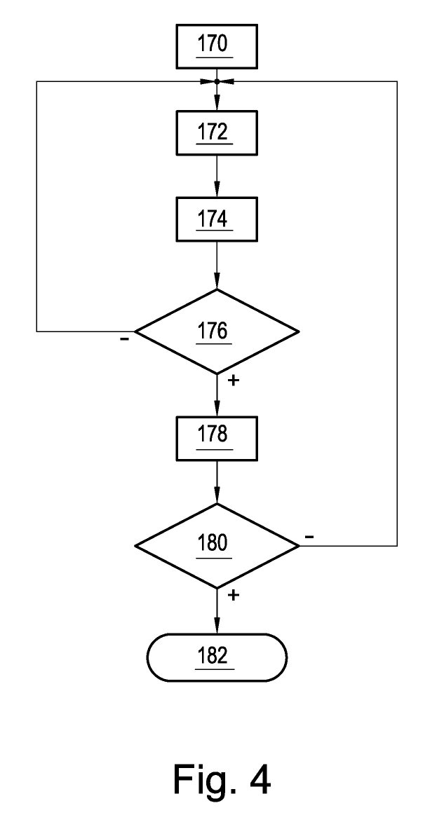

As illustrated in FIG. 4, the data exchange protocol between the initiator 2 and target 4 starts with step 170 by determining the number N of data blocks and initializing a block counter i to 1 in the initiator controller 22. Then, initiator 2 sends in step 172 the current block B(i) via a request command. The target 40 responds in step 174 by sending acknowledgement status information ACK(i).

A first test is carried out in step 176 to find out if the ACK(i) indicates that the block B(i) has been correctly received, the counter i is incremented 178 by one and the next block is transmitted. If not, the block B(i) is sent again by the target 4.

A second test if the counter i exceeds N is performed in step 180, then the data exchange protocol is terminated in step 182. By using such a protocol, NFC technology can be used to transfer an emergency call data message of any length.

Thus, freedom of access provided by NFC technology enables any mobile phone equipped with such a radio interface to receive information data from the emergency call sensing apparatus when requested for assistance. It will be therefore only required to position the mobile phone close enough to the crashed vehicle.

As the NFC radio range is short, i.e. less than one meter, even shorter when using NFC technology, using two mobile phones to relay the emergency call at the same time will be rare in practice. Even if such a case occurs, the disabling functionality as provided by disabling device 50 will solve this problem.

Meanwhile, NFC technology provides a universal wireless interface to relay emergency calls, with which no preparation time is required to set up a procedure for access to the mobile phone, which results in diminishing the response time of the emergency call system. Another advantage is that NFC is easy to implement in a mobile as specified for pocket-size devices.

Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention, as hereinafter claimed.

1. An emergency call system comprising:
an emergency call sensing apparatus including:
an emergency event sensor adapted to sense an emergency event and to provide a command to send an emergency radio signal;
a first wireless communication device adapted to communicate with a mobile unit to send an emergency radio signal upon receipt of the command sent by the emergency event sensor; and
an emergency control unit to coordinate tasks, to handle a communication with the mobile unit through the first wireless communication device and to provide emergency call data in case of an emergency event sensed by the emergency event sensor; and
at least one mobile unit that can be located near the emergency call sensing apparatus, said at least one mobile unit including:
a second wireless communication device operative to communicate with the first wireless communication device to receive the emergency radio signal;
a third wireless communication device operative to establish an emergency call through a wireless public communication network to a predefined destination upon receipt of the emergency radio signal; and
a mobile control unit to coordinate tasks between the second wireless communication device and the third wireless communication device.

2. The emergency call system of claim 1, wherein
the first wireless communication device implements Near Field Communication (“NFC”) technology to transmit the emergency radio signal,
the second wireless communication device implements NFC technology to receive the emergency radio signal from the emergency call sensing apparatus, and
the emergency call sensing apparatus is able to access the at least one mobile unit without using any access control command data generated by the at least one mobile unit.

3. The emergency call system of claim 1, wherein the emergency call sensing apparatus further comprises an emergency call storage unit containing the emergency call data related to the emergency radio signal as prerecorded voice codec data and/or emergency call sensing apparatus positioning data.

4. The emergency call system of claim 1, wherein the emergency call sensing apparatus further comprises a positioning signal receiver unit operative to provide positioning data to be incorporated into the emergency radio signal as emergency data.

5. The emergency call system of claim 1, wherein the emergency call sensing apparatus further comprises a voice codec unit operable to convert an analog voice message into a prerecorded voice data message to be incorporated into the emergency radio signal.

6. The emergency call system of claim 1, wherein the at least one mobile unit further comprises a mobile storage data base to store the totality of the emergency data sent by the emergency call sensing apparatus.

7. The emergency call system of claim 1, wherein the mobile unit further comprises a positioning receiver unit operative to receive mobile positioning data, and means for encapsulating the mobile positioning data in the emergency call data to provide complete emergency call data to be sent to the predetermined destination through the third wireless communication device.

8. The emergency call system of claim 1, wherein the mobile unit further comprises an emergency call disabling device operative to deactivate the second wireless communication device in response to a user command.

9. The emergency call system of claim 1, further comprising
a plurality of mobile units operative to be located near the emergency call sensing apparatus wherein each mobile unit including a second wireless communication device implements NFC technology, and
the emergency call sensing apparatus is operative to freely access each mobile unit of the plurality of mobile units without using any access control command generated by each unit of the plurality of mobile units.

10. The emergency call system of claim 9, wherein each the mobile unit includes the means for establishing an emergency call to a same predefined destination when the mobile unit receives an emergency signal from the emergency call sensing apparatus.

11. The emergency call system of claim 1, wherein the emergency call sensing apparatus segments the emergency radio signal into a number of data blocks or transmission bursts using an Automatic Request protocol (“ARQ”) to transmit all the data of the emergency radio signal.

12. A method for gaining emergency assistance in an emergency, the method comprising the steps of
determining the occurrence of an emergency event;
transmitting an emergency radio signal through a wireless communication using Near Field Communication (“NFC”) technology when the emergency event has been sensed;
receiving the emergency signal transmitted through the wireless communication using NFC technology; and
processing the emergency signal independent of control command data generated by the source of the emergency signal using NFC technology.

13. The method of claim 12 wherein the emergency radio signal includes emergency call data.

14. The method of claim 13 further comprising storing the emergency call data

15. The method of claim 13 wherein emergency call data includes positioning data.

16. The method of claim 13 further comprising receiving at a positioning receiver mobile positioning data.

17. The method of claim 16 further comprising encapsulating the mobile positioning data in the emergency call data and sending the emergency call data to a predetermined destination.

18. The method of claim 12 further comprising segmenting the emergency radio signal into a number of data blocks or transmission bursts using an Automatic Request (“ARQ”) protocol to transmit all data of the emergency radio signal.
